(19) United States
(12) Patent Application Publication
(10) Pub. No.: US 2007/0237145 A1
(43) Pub. Date: Oct. 11, 2007

(54) Comparison based authentication in RTP

(75) Inventors: Akshay Adhikari, Basking Ridge, NJ (US); Sachin Garg, Green Brook, NJ (US); Anjur S. Kishnakumar, Rocky Hill, NJ (US); Navjot Singh, Denville, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology LLC

(21) Appl. No.: 11/393,605

(22) Filed: Mar. 30, 2006

(51) Int. Cl. H04L 12/56

(52) U.S. Cl. 370/392

(57) ABSTRACT

A method of authenticating a communications between a sender and a receiver includes agreeing, by a sender and receiver, on a shared secret, computing a first sequence of numbers at the sender using the shared secret, and computing a second sequence of numbers at the receiver using the shared secret. Successive values of the first sequence are respectively embedded in successive messages by the sender. Upon receiving a message, the receiver compares the embedded value of the first sequence with a list of values including at least one corresponding value from the second sequence and the received message to considered to originate from an authentic sender if the value of the first sequence matches the value of the second sequence. The method value is removed from a list of values in the second sequence for comparing.

### BACKGROUND OF THE INVENTION

The present invention relates to an authentication mechanism for sequenced message streams and a method for performing the authentication mechanism.

As Voice over Internet Protocol (VoIP) deployment becomes more prevalent, Denial of Service (DoS) attacks against them have become a cause of concern. The Real-Time Transport Protocol (RTP) is an Internet protocol standard that specifies a way for programs to manage real-time transmission of multimedia data. RTP is commonly used with Internet telephony. The functioning of VoIP device can be impaired by sending fake RTP packets, which, if spoofed properly, are played back resulting in degraded audio quality. The Secure Real-Time Transport Protocol (SRTP) defines a profile of RTP intended to provide encryption, message authentication and integrity, and replay protection to RTP data such as, for example, Voice over Internet Protocol (VoIP). Authentication is generally performed by attaching an authentication tag to the message to be sent. The tag is calculated using a cryptographically secure hash algorithm, such as HMAC-SHA1. The recipient of the message must recompute the tag for every message received, and verify that it matches the one attached to the message.

The protection afforded by SRTP comes with a cost. The hash algorithms used typically incur a high processing overhead. This provides another avenue for a DoS attack. Simply flooding a telephony device with a fake stream of packets causes the device to consume a lot of CPU cycles on authenticating and rejecting them. Depending on the processing power of the device, it is possible to impair its regular functioning with a rate of fake packet traffic that is significantly lower than the device's network capacity. In some cases, even a reasonably low rate packet flood may impair normal functioning of the device.

Three schemes have been proposed to enhance the ability to tolerate DoS attacks against VoIP devices that implement SRTP. The first of these schemes requires that the sender and receiver negotiate a key and a seed so that they independently generate the same cryptographically secure pseudo random number series. Each packet is associated with a sequence number and the receiver must only compare the random number to authenticate the packet. A disadvantage with this scheme is that packets within a certain window are susceptible to a packet replay attack.

A second scheme for enhancing the ability to tolerate DoS attacks against VoIP devices involves computing a hash over fewer bytes. However, this scheme still requires that a hash be computed by the receiver for every packet received. Therefore, this scheme is computationally expensive.

According to a third scheme, the sender calculates in advance a series of random numbers and uses a number as the authentication tag for each packet. The series of random numbers are sent to the receiver along with the RTP payload. However, a disadvantage of this third scheme is that the size of the RTP packet increases by the additional random sequence of numbers transmitted.

### SUMMARY OF THE INVENTION

An object of the present invention is to provide a method for authenticating sequenced message streams which overcomes the problems of the prior art.

The object is met by a method of authenticating a communication between a sender and a receiver including computing a first sequence of numbers at the sender and computing a second sequence of numbers at the receiver, wherein the second sequence is the same as the first sequence. Successive values of the first sequence are embedded in successive messages sent by the sender. Upon receiving a message, the receiver compares the embedded value with an expected corresponding value from a list of values to be compared comprising at least one value from the second sequence. The received message is considered to be from an authentic sender if the embedded value matches the expected corresponding value. The matched value is then removed from the list of values to be compared to prevent replay attacks.

Accordingly, the authentication according to the present invention is based on comparisons, which makes it very lightweight. The mechanism may be used with Secure Real-Time Transport Protocol (SRTP).

The first and second sequences of numbers may be generated by a hash algorithm based on a secret key and a seeding hash agreed upon by the sender and receiver. The sequence numbers of the first and second sequences are truncated hashes generated by the hash algorithm.

The messages sent between the sender and receiver may comprise RTP packets of a VoIP media stream. The received messages may be sent to an SRTP layer if the received message is considered to originate from an authentic sender.

The first and second sequences may alternatively be generated using a Pseudo Random Number Generator. In this case, the shared secret may comprise a key used for AES encryption.

The receiver stores a window of N sequence numbers from the second sequence and comparisons of the sequence number of the received packet are made only with the N sequence numbers in the window. If a message with the lowest sequence number of the N sequence number is received, the window slides by one sequence number in the second sequence. After a packet is successfully authenticated, the receiver replaces the sequence number with a number outside the current window, thereby preventing replay attacks.

A loss of synchronization between the receiver and the sender may be determined by determining whether the window lags behind the messages sent by the sender. This may be accomplished by monitoring a lifetime of a current window and determining whether the lifetime of the current window exceeds a predetermined time period.

Upon detecting a loss of synchronization, packets that are not authenticated are passed to an SRTP layer to perform authentication at the SRTP layer. The first packet to be authenticated by the SRTP layer may be used to resynchronize the receiver by setting the window to begin after the first packet to be authenticated by the SRTP layer. Setting the window may comprise computing the sequence of numbers from the sequence number of the last packet authenticated to the first packet to be authenticated by the SRTP layer. Alternatively, setting the window may be effected by including the authentication sequence number of the first packet authenticated by the SRTP layer as part of the SRTP payload.

Detection of a loss of synchronization may alternatively be accomplished by tracking a position of received packets within the window.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flow diagram of the steps for communicating an RTP media stream according to the present invention;

FIG. 2 is a sequence diagram showing the flow of information between a sender and a receiver for communicating the RTP media stream according to FIG. 1;

FIG. 3 is a flow diagram of the steps for communicating an RTP media stream according to another embodiment of the present invention;

FIG. 4 is a sequence diagram showing the flow of information between a sender and receiver for communicating the RTP media stream according to FIG. 3;

FIG. 5 is a flow diagram showing further steps according to the present invention;

FIG. 6 is a flow diagram of steps for detecting loss of synchronization;

FIG. 7 is a flow diagram showing further steps for detecting loss of synchronization;

FIG. 8 is a flow diagram showing alternative steps for recovering synchronization;

FIG. 9 is a flow diagram for re-initializing synchronization;

FIG. 10 is a schematic diagram of a network in which the present invention is implemented; and

FIG. 11 is an algorithm listing for the method according to the present invention.

### DETAILED DESCRIPTION OF THE PRESENTLY PREFERRED EMBODIMENTS

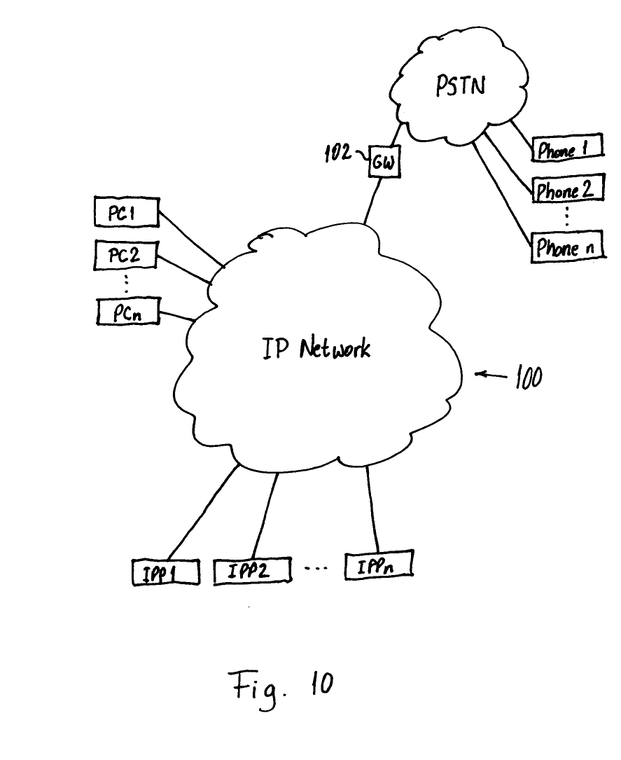

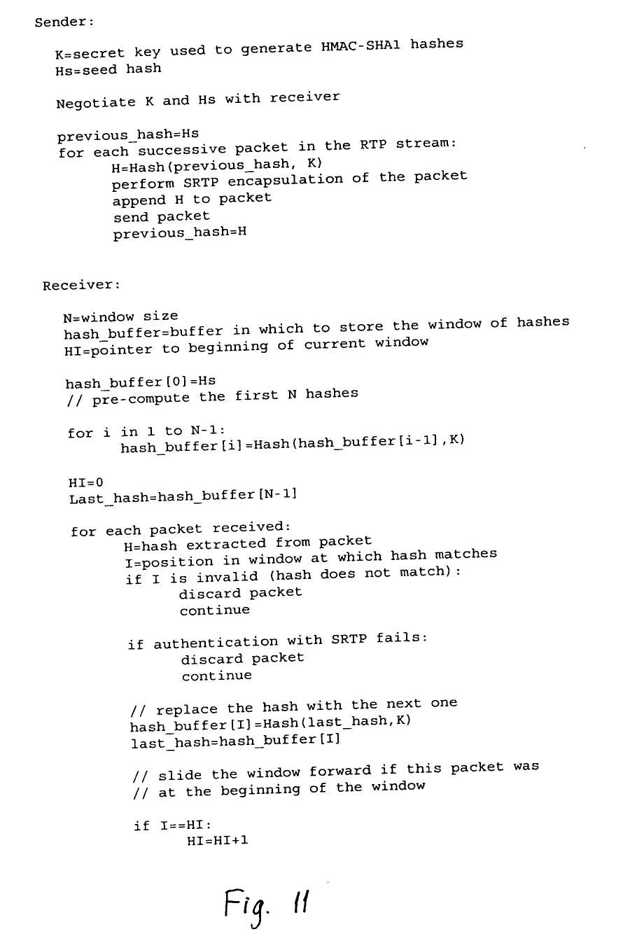

The present invention relates to a method for communicating an RTP media stream between two network endpoints, i.e., a sender and a receiver. FIG. 10 is a simplified network showing various types of endpoints that may be connected to an IP Network 100 such as, for example, the Internet. The various endpoints include personal computers PC1, PC2, . . . PCn, IP Phones IPP1, IPP2, . . . IPPn, and phones P1, P2, . . . Pn. The personal computers PC1, PC2, . . . PCn, IP Phones IPP1, IPP2, . . . IPPn are directly connected to the IP network 100 by a service provider. The phones P1, P2, . . . Pn are connected to a Public Switched Telephone Network (PSTN) which is connected to the IP Network 100 by a gateway 102. The method described below can be performed on an RTP media stream between any two of the endpoints shown in FIG. 10 such as, for example, Voice over Internet Protocol (VoIP) streams. The communication between the two endpoints may be a full duplex. However, only one direction of communication will be described below. The same method applies to the reverse direction.

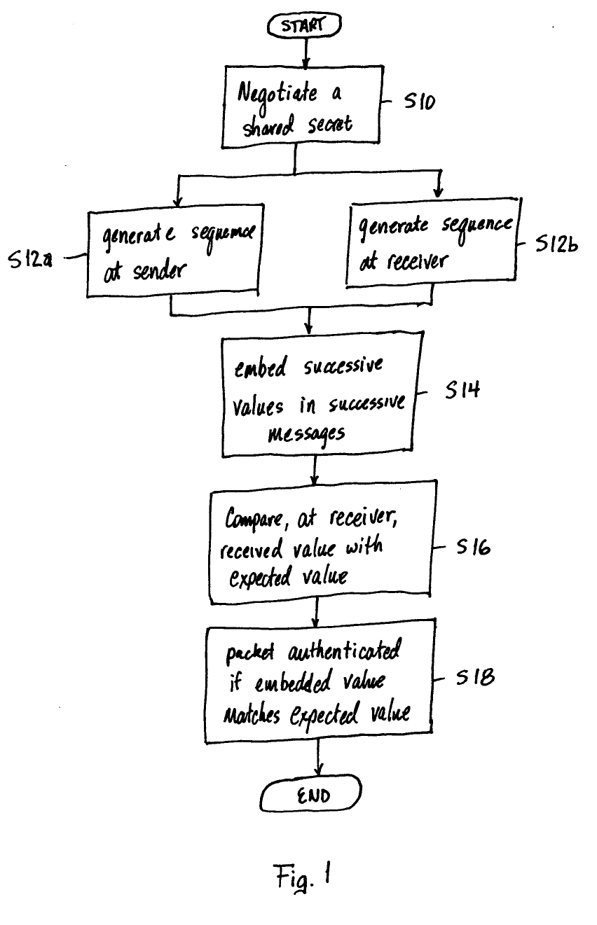

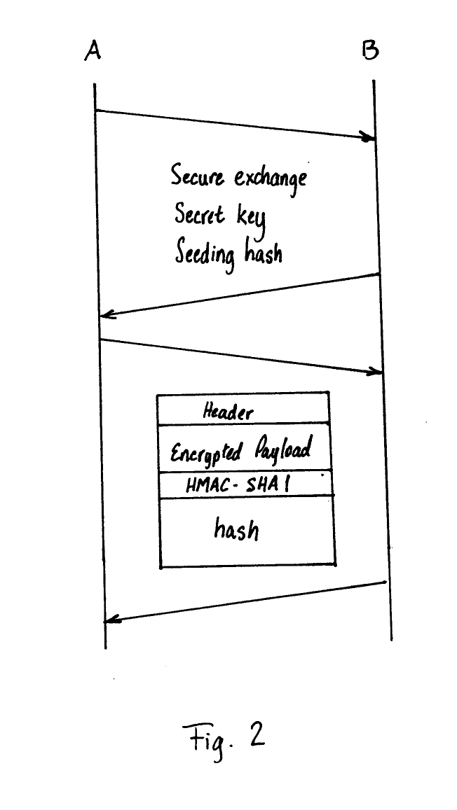

According to a FIGS. 1 and 2, a sender A and receiver B agree on a secret such as, for example, a secret key K and a seeding hash Hₛ, step S10. One example for agreeing on a secret is for a gatekeeper to generate a key during the call setup phase and sent it to the communicating parties over a previously established secure channel. For example, in an Avaya H.323 deployment, IP phones establish a secure communication channel with a gatekeeper, i.e., a Communication Manager, at registration. Then at call setup, the gatekeeper generates a secret key and sends it to both phones.

At steps S12a and S12b, the sender and the receiver each independently compute a sequence of numbers Na and Nb from the shared secret. The sequences are the same such that Na=Nb. The sequence is referred to hereafter as sequence Ns and is cryptographically secure so that no other party can generate Ns without knowledge of the shared secret. Furthermore, an attacker should not be able to generate some or all of the elements of Ns given knowledge of the some of the elements of Ns. More specifically, the would-be attacker should not be able to generate Ns(i+1), if the attacker knows Ns(i). One example is a sequence of hashes generated using a cryptographically secure hash algorithm hash( ) such as HMAC-SHA1, wherein the hash values are computed as follows:
H₀=Hash(Hₛ, K), and
Hᵢ=Hash(Hᵢ₋₁, K) for i>=1.

The hash algorithm HMAC-SHA1 computes 20 byte hashes. However, the hash values used may be truncated to a smaller length L, such as, for example, by using the first L bits of the 20 byte hash.

The sender embeds successive hashes of the sequence in the successive messages sent to the receiver, step S14. Since the receiver knows which packet to expect next in the stream, the receiver compares the hash of the received packet with the expected hash (which the receiver has already computed), step S16. Once the packet is authenticated by matching the hash of the received packet with the expected hash, step S18, the receiver can replace the expected hash with the next one in the sequence. Once the packet is authenticated, it can be passed onto the SRTP layer.

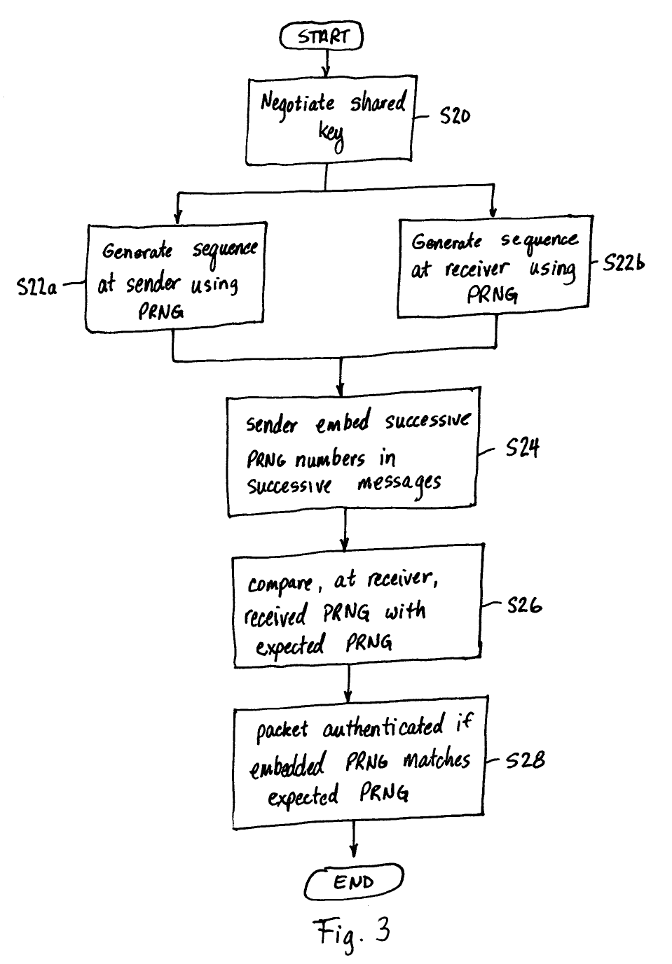

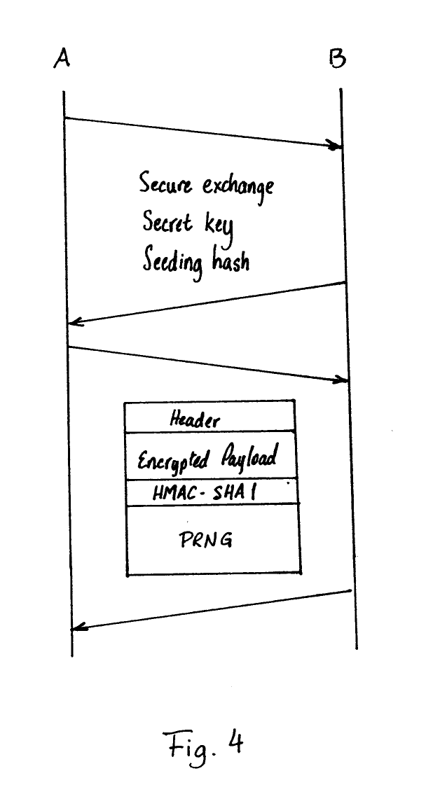

FIG. 3 and 4 show another example of generating a sequence Ns using a Pseudo Random Number Generator (PRNG). At step S20, the sender and receiver agree on a shared key. This could be piggy-backed on the key exchange mechanism for SRTP functionality. The same key used for AES encryption may be used. Each of the sender and receiver then independently generate the sequence Ns of PRNG numbers using the key and the PRNG, steps S22a and S22b. The key may be used as a seed for a known PRNG to generate Ns. The sender then embeds successive PRNG numbers of the sequence in the successive messages, step S24. The receiver compares the PRNG number of the received packet with the expected PRNG number (which the receiver has already computed), step S26. Once the packet is authenticated by matching the packet PRNG number with the expected PRNG number, step S28, the receiver can replace the expected PRNG number with the next one in the sequence.

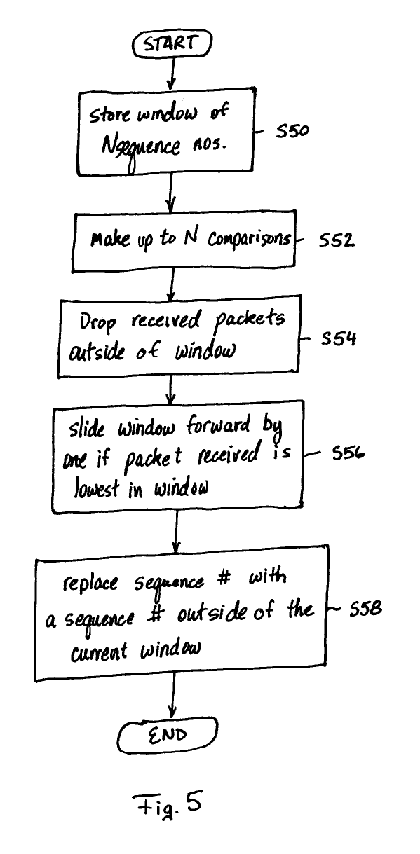

FIG. 5 shows the steps for handling out of order packet arrival and packet loss. The receiver stores a window of N sequence numbers of the sequence Ns, step S50. When a message arrives, a maximum of N comparisons are performed to authenticate the message, step S52. Accordingly, the number N must be calibrated or set according to how far out of order the receiver can or is willing to accept the messages. The media codec being used may determine the number N. If packets arrive that are outside of the window, they are dropped, step S54.

If the packet received is the lowest one in the window, then the window slides forward in the sequence Ns, step S56. Furthermore, when a packet is successfully authenticated and it is no the lowest one in the window, it is replace by the sequence number after the last packet of the window, step S58. This provides protection against packet replay attacks in which an attacker captures a valid packet, spoofs the client that it captured the packet from and replays the packet over and over again. The expensive process of computing a new hash is performed only when a legitimate packet is received, not with the reception of every packet.

If packet loss occurs, the receiver may lose synchronization with the sender in that the window of acceptable packets may lag behind the packets sent by sender. Accordingly, it is necessary for the receiver to occasionally resynchronize with the sender. Without the resynchronization, legitimate packets could be dropped.

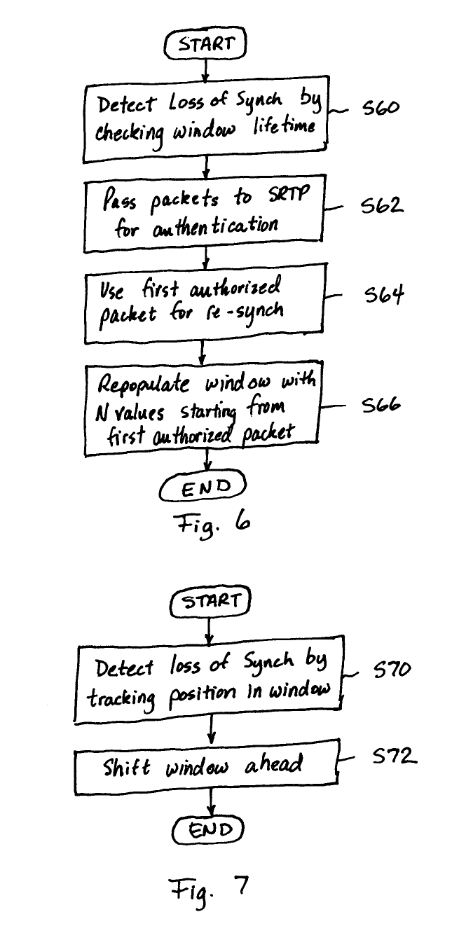

FIG. 6 shows a first embodiment for detecting loss of synchronization and then recovering the synchronization. One symptom of synchronization loss is that legitimate packets are not received at an expected frequency (which is determined by the codec). Accordingly, one way to determine synchronization loss is to track the lifetime of a current window. For example, if a codec specifies that packets are to be received every S seconds, then the lifetime of a window is N*S and it should progress by N every S seconds. If it is determined that the window progresses slower than this rate, then a loss of synchronization is detected by the receiver, step S60. After the loss of synchronization is detected, the packets that fail the authentication of the steps S16, S26 of comparing and steps S18, S28 of considering (FIGS. 1 and 3) are passed to the SRTP layer for the more computationally expensive authentication. The first packet to be authenticated by the SRTP layer is used to resynchronize the receiver, step S64. The window is then repopulated with N values, step S66, starting from the sequence value of the first packet to be authenticated by the SRTP layer. Even when the receiver is under a Denial of Service (DoS) attack, one legitimate packet will eventually be authenticated by the SRTP layer, at which point synchronization is regained. Once synchronization is recovered, the ability to tolerate a packet flood attack is also recovered.

FIG. 7 shows another embodiment which may be used for detecting loss of synchronization. According to FIG. 7, a position of the received packet within the current window is tracked. If the last few packets that are received are closer to end of the window, i.e., in the last half of the window, the receiver detects a loss of synchronization, step S70. The window is then moved ahead, step S72 to recover the synchronization. Careful calibration is required to determine the amount of the shift. Shifting the window too far forward may result in the loss of legitimate packets from the original window which were delayed.

FIG. 8 shows yet another embodiment for addressing synchronization. According to FIG. 8, every T seconds, authentication with STRP is performed, step S80. Synchronization is then recovered as needed, step S82.

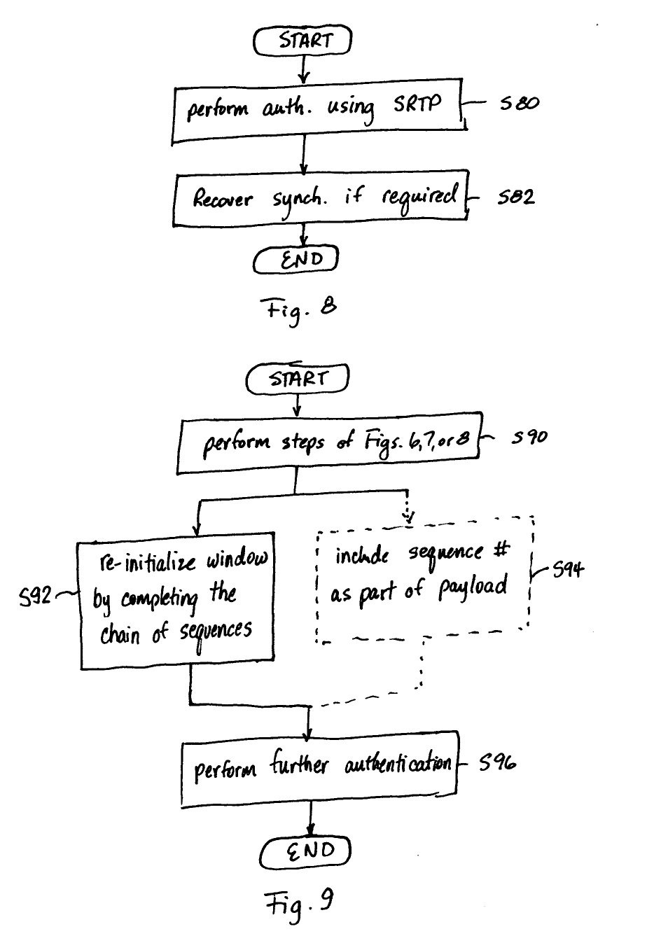

After performing the steps of FIGS. 6, 7, or 8, step S90 (FIG. 9), the window of N current sequence numbers must be re-initialized. This may be accomplished by completing the chain of sequence numbers leading to the sequence number of the packet with which to synchronize, step S92. Alternatively, the sequence number of the packet with which to synchronize may be sent with the SRTP payload, step S94. If the sequence number is not included in the payload, an attacker could replace the sequence number with one of his own choosing. This is referred to as a man in the middle attack. The sequence number would be trusted because there is no integrity check on it as would other sequence numbers derived from it. The inclusion of the sequence number in the SRTP payload requires the SRTP layer to perform HMAC-SHA1 over the RTP payload and an extra L bits. Depending on the payload size, the extra bits may not be an overhead, because SHA1 works on 64 byte blocks. For example, for the G.711 codec, increasing the number of bytes to be hashed from 172 to 176 still requires only 6 blocks to be hashed as per equation.

Another variation of the man in the middle attack is when the attacker can modify the contents of the packet. The attacker may modify the contents and then send the modified copy or copies onward. If the modified packets reach the recipient first, communication will be disrupted. To obviate this problem, when a packet is received and the hash or other sequence number is verified, the packet is passed onto the. SRTP where the hash is computed over the entire payload, which helps reject modified copies. However, this solution imposes extra overhead which must be weighed against the benefit of protection against man in the middle attacks.

L is an important parameter of our protocol. Since L bits are appended to every packet, we must keep it small to minimize the overhead of transmitting the extra L bits. L also determines the probability of an attacker generating the right hash for a packet. A brute force attacker would simply send a flood of 2^{L} packets, and the hash for one of these packets will match the real one. Of course, the fake packet will be rejected by the SRTP layer as described above. Therefore, the only disadvantage would be the extra overhead of SRTP in ensuring that we are not accepting a fake packet. However, even a reasonably small value of L makes the probability very small, and makes a brute force attack much harder. For example, L=32 would imply that a brute force attacker would have to send 2³² packets between the inter-arrival time of legitimate packets (20 ms for the G.711 codec) to incur the extra overhead of SRTP.

FIG. 11 is a listing of the algorithms performed by the sender and receiver for communicating a media stream according to the method of FIGS. 1 and 2. Of course each terminal should be capable of being a sender and a receiver. Accordingly, each terminal according to the present invention will be programmed to perform both the sender algorithm and the receiver algorithm.

According to FIG. 11, the sender negotiates a secret key K to generate HMAC-SHA1 hashes and a seed hash Hₛ. A previous_hash field is initially set to equal the seed hash Hₛ. For each successive packet which is sent in the RTP stream, the sender computes a hash H using the previous_hash and the key K, performs SRTP encapsulation of the packet and appends the computed hash to the packet. The packet is then sent and the previous_hash is set to H.

The receiver negotiates K and Hₛ with the sender. The receiver includes a hash_buffer which stores a window of hashes and a pointer HI which points to the beginning of a current window. The receiver first sets the first entry in the hash buffer as the hash seed Hₛ, fills the hash_buffer with the first N hashes by computing the first N hashes, sets the pointer HI to 0, and sets a last_hash to the hash_buffer[N-1]. For each packet received, the receiver extracts the hash from the packet and sets H to the extracted hash, determines the position in the window which matches H. If the hash H is not matched, I is invalid and the packet is discarded. If authentication with SRTP fails, the packet is discarded.

If the hash matches, the hash_buffer[I] is replaced with hash(last_hash,K). If I was at the beginning of the window, then the window is slid forward by one place.

Although the above examples refer to VoIP media streams, the method according to the present invention is applicable to authentication of any sequenced message stream. It also provides for one-time pads that can be used for lightweight encryption.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of authenticating a communications between a sender and a receiver, comprising the steps of:
agreeing, by a sender and receiver, on a shared secret;
computing a first sequence of numbers at the sender using the shared secret and computing a second sequence of numbers at the receiver using the shared secret;
embedding successive numbers of the first sequence in successive messages by the sender;
upon receiving a message, comparing, at the receiver, the embedded number of the first sequence with a list of numbers to be compared comprising at least one number the second sequence; and
considering the received message to originate from an authentic sender if the embedded number of the first sequence matches a number of the second sequence in said step of comparing; and
removing the matched number from the list of numbers to be compared, thereby preventing replay attacks.

2. The method of claim 1, wherein each of said first and second sequences in generated as a sequence of hashes.

3. The method of claim 1, wherein, when the first and second sequences of numbers are generated by a hash algorithm based on a secret key and a seeding hash agreed upon by the sender and receiver.

4. The method of claim 1, wherein the number of the sequences are truncated hashes generated by the hash algorithm.

5. The method of claim 1, wherein the messages are RTP packets.

6. The method of claim 1, wherein the messages are packets of a VoIP media stream.

7. The method of claim 5, wherein said step of considering comprises passing the message to an SRTP layer if the received message is considered to originate from an authentic sender.

8. The method of claim 1, wherein each of said first and second sequences is generated using a Pseudo Random Number Generator.

9. The method of claim 8, wherein the shared secret comprises a key used for AES encryption.

10. The method of claim 1, wherein the corresponding number is the next number in the second sequence.

11. The method of claim 1, wherein the list of numbers to be compared comprises a window of N sequence numbers from the second sequence stored by the receiver and said step of comparing comprises making comparisons for a message with only the stored N sequence numbers.

12. The method of claim 11, if a message with the lowest sequence number of the N sequence number is received, sliding the window slides by one sequence number in the second sequence.

13. The method of claim 11, wherein said step of removing comprises, after a packet is successfully authenticated in said step of considering, replacing, by the receiver, the associated number by a number outside the current window, thereby preventing replay attacks.

14. The method of claim 11, further comprising the step of detecting a loss of synchronization between the receiver and the sender by determining whether the window lags behind the messages sent by the sender.

15. The method of claim 14, wherein said step of detecting the loss of synchronization comprising monitoring a lifetime of a current window.

16. The method of claim 15, wherein said step of detecting comprises detecting a loss of synchronization when the lifetime of the current window exceeds a predetermined time period.

17. The method of claim 14, wherein, upon detecting a loss of synchronization, passing packets that are not authenticated by said steps of comparing and considering to an SRTP layer to perform authentication at the SRTP layer.

18. The method of claim 17, further comprising the step of using a first packet to be authenticated by the SRTP layer to resynchronize the receiver by setting the window to begin after the first packet to be authenticated by the SRTP layer.

19. The method of claim 18, wherein said step of setting the window comprises computing the sequence of numbers from the sequence number of the last packet authenticated by said step of comparing to the first packet to be authenticated by the SRTP layer.

20. The method of claim 18, wherein said step of setting the window comprises including the authentication sequence number of the first packet authenticated by the SRTP layer as part of the SRTP payload.

21. The method of claim 20, wherein the sequence comprises a sequence of hashes and the hash received as part of the SRTP payload is further authenticated by computing the SRTP hash over the entire payload.

22. The method of claim 14, wherein said step of detecting a loss of synchronization comprises tracking a position of received packets within the window.

23. The method of claim 22, wherein said step of detecting comprises detecting the loss of synchronization when the embedded number of the received packet is closer to the end of the window than to the front of the window.

24. A communication terminal comprising a memory storing computer-executable instructions, when the communication terminal is a receiver terminal for receiving a sequence of packets from a sender terminal, the computer executable instructions performing the steps of:
precomputing a first N sequence_numbers of a sequence using an algorithm and a key negotiated with the sender terminal;
setting the N sequence_numbers in a window buffer;
setting a window pointer to a beginning of the window; and
for each packet received from the sender,
extracting a sequence_number value from the each received packet;
determining whether one of the N sequence_numbers in the window buffer matches the extracted sequence_number,
determining that a packet is authentic if a match is determined and removing the matched one of the N sequence_numbers from the window buffer; and
discarding the packet if a match can not be determined.

25. The communication terminal of claim 24, wherein the computer executable steps further comprise, if a match is determined in said step of determining, then determining the position of the matched sequence_number in the window, computing the next sequence_number using the algorithm and the key, replacing the matched sequence_number in the window with a next sequence_number, and sliding the window forward if the matched sequence_number was at the beginning of the window.

26. The communication terminal of claim 24, wherein each sequence_number of said window is computed using an algorithm operating on the previous_sequence_number and the key.

27. The communication terminal of claim 26, wherein each of the sequence_numbers is a hash value and the algorithm is a hash algorithm.

28. The communication terminal of claim 24, wherein, the memory storing further computer-executable instructions when the communication terminal is a sender terminal for sending a sequence of packets to a receiver terminal the further computer-executable instructions performing the steps of:
setting a previous_sequence_number variable to a seed value; and
for each successive packet to be sent in a media stream,
computing a sequence_number using an algorithm operating on a key negotiated with a receiver terminal;
appending the computed sequence_number to the packet;
transmitting the packet to the receiver terminal; and
setting the previous_sequence_number variable to the computed sequence_number.

29. The communication terminal of claim 28, wherein said computer executable instructions further perform the steps of performing SRTP encapsulation of the each successive packet after said step of computing a sequence_number and before said step of appending the computed sequence_number.

30. The communication terminal of claim 28, wherein said computer executable step of computing a sequence_number comprises computing a sequence_number using an algorithm operating on the previous_sequence_number and the key.

31. The communication terminal of claim 28, wherein said computer executable step of computing a sequence_number comprises computing a hash value using a hash algorithm operating on the previous_sequence_number and the key.
